(19) United States
(12) Patent Application Publication
(10) Pub. No.: US 2019/0366744 A1
(43) Pub. Date: Dec. 5, 2019

(54) PRINTING SYSTEM FOR CUT SHEETS COMPRISING A PAPER PATH WITH A LOOP AND A METHOD THEREFOR

(71) Applicant: Océ Holding B.V., Venlo (NL)

(72) Inventors: Jacobus J. KANDELAARS, Venlo (NL); Louis J.A.M. SOMERS, Venlo (NL); Patrick G.H. VESTJENS, Venlo (NL); Umar WAQAS, Venlo (NL)

(73) Assignee: Océ Holding B.V., Venlo (NL)

(21) Appl. No.: 16/540,714

(22) Filed: Aug. 14, 2019

Related U.S. Application Data
(63) Continuation of application No. PCT/EP2018/053696, filed on Feb. 14, 2018.

(30) Foreign Application Priority Data
Feb. 22, 2017 (EP) 17157311.6

(51) Int. Cl. B41J 13/00

(52) U.S. Cl. CPC B41J 13/0045

(57) ABSTRACT

The present invention relates to a printing system for cut sheets. The printing system comprises a paper path comprising a loop in order to enable duplex printing on the sheets in a continuous flow of sheets in a first and second interweaving pass in the loop. A controller controls simplex and/or duplex printing of image data on the continuous flow of sheets. A print engine is positioned in the loop configured to dispose marking material on the sheets according to the image data. A scheduler time schedules the continuous flow of sheets in an order of a plurality of actions comprising loading a sheet, printing the sheet in a first pass in the loop, printing the sheet in a second pass in the loop, and unloading the sheet. The scheduler is configured to use a digital representation of a directed graph of vertices and edges, each vertex representing an action of the plurality of actions on a sheet of the continuous flow of sheets and each edge representing an amount of time needed for a sheet to go from a starting vertex of the edge to an ending vertex of the edge. The directed graph also represents interweaving of sheets from a first pass and a second pass. The scheduler comprises a digital window mover for providing subsequent windows over the directed graph. Each window of the subsequent windows covers a finite subset of the vertices of the directed graph which correspond to actions on a number of subsequently sheets to be processed in the continuous flow of sheets, as to allow repetitive executions of an algorithm for finding a shortest path between vertices covered by the window. A window size determines for each window of the subsequent windows the amount of vertices in the window and a window step size determines which vertices are covered by the subsequent windows respectively.

### CROSS REFERENCE TO RELATED APPLICATIONS

This application is a Continuation of International Application No. PCT/EP2018/053696, filed on Feb. 14, 2018, and for which priority is claimed under 35 U.S.C. § 120. PCT/EP2018/053696 claims priority under 35 U.S.C. § 119 to Application No. 17157311.6, filed in Europe on Feb. 22, 2017. The entirety of each of the above-identified applications is expressly incorporated herein by reference.

### BACKGROUND OF THE INVENTION

### Technical Field of the Present Invention

The present invention relates to a printing system for cut sheets, the printing system comprising a paper path comprising a loop in order to enable duplex printing on the sheets in a continuous flow of sheets in a first and second interweaving pass in the loop, a controller for controlling simplex and/or duplex printing of image data on the continuous flow of sheets, a print engine positioned in the loop configured to dispose marking material on the sheets according to the image data, and a scheduler for time scheduling the continuous flow of sheets in an order of a plurality of actions comprising loading a sheet, printing the sheet in a first pass in the loop, printing the sheet in a second pass in the loop, and unloading the sheet, wherein the scheduler is configured to use a digital representation of a directed graph of vertices and edges, each vertex representing an action of the plurality of actions on a sheet of the continuous flow of sheets and each edge representing at least one amount of time needed for a sheet to go from a starting vertex of the edge to an ending vertex of the edge, the directed graph also representing interweaving of sheets from a first pass and a second pass.

Such a printing system will also be called a production printer hereinafter. The actions mentioned here-above will also be called sub-tasks or operations hereinafter. The loop may contain a buffered part and a non-buffered part.

### Background of the Present Invention

In the paper path of a printing system each of the plurality of sheets is transported from an input section of the printing system towards a print head or print assembly. By means of the print head or print assembly marking material is disposed on each of the plurality of sheets. Each of the plurality of sheets is transported from the print head or print assembly towards an output section of the printing system.

To enable duplex printing the paper path contains a loop, a so-called duplex loop. A sheet enters the loop in a first pass in order to print image data on one side of the sheet, goes through the duplex loop and enters the duplex loop in a second pass in order to print image data on the other side of the sheet. However, simplex printing—printing on one side of a sheet—may also be executed by means of the loop in the paper path or without using the loop in the paper path. The present invention relates to simplex printing as well as to duplex printing, i.e. for simplex printing as well as duplex printing the loop is used. A print engine with a loop may have a print speed of twice as high as a speed of a separation in the input module and a working speed of an output module or finisher. In such a case and also in general the loop may be used to print on the plurality of sheets by interweaving the plurality of sheets in the first pass and in the second pass.

The controller of the printing system comprises a scheduler to time schedule the sheets for processing. First of all the sheets are sequenced and thereafter scheduled. Sequencing of the sub-tasks comprising loading a sheet, printing the sheet in a first pass in the loop, printing the sheet in a second pass in the loop, and unloading the sheet, in such a printer is a special case of a flowshop problem called “A re-entrant flowshop heuristic for online scheduling of the paper path in a large scale printer” as described by Umar Waqas et al. (“Proceedings of the 2015 Design, automation & Test in Europe Conference & Exhibition”. DATE '15. Grenoble, France: EDA Consortium, 2015, pp. 573-578. ISBN 978-3-9815370-4-8). After online sequencing of the sub-tasks, the sub-tasks need to be online scheduled.

In the case of a production printer there is a chance that new information may come into the print queue as part of new print jobs arriving at the production printer. Therefore a scheduler for a production printer needs to be able to compute schedules at a pace at least as fast as the printer's printing. Only then the printer can actually output the sheets at regular intervals. The scheduler should also be able to consider information about new print jobs joining the print queue while making its scheduling decisions.

A re-entrant flowshop problem provides a near optimal sequence of sheets as a solution to the operations re-entering into the same duplex loop from different sheets. To establish a correctness of the solution, the sequencing needs to be validated for constraints on the sequence of operations and if valid, the sequence of operations need to be given start times. This is referred to as scheduling. The constraints may be integrated into the directed graph leading to a constraint graph which has edges of both polarities, positive and negative. Shortest path algorithms are well-known which can handle constraints graphs with both positive and negative edges, for example a Bellman-Ford algorithm.

Therefore the scheduler of the production printer uses the Bellman-Ford algorithm to validate the sequences and schedule the operations on the sheets. The Bellman-Ford algorithm works on the principle of relaxing as explained in Wikipedia (URL https://en.wikipedia.org/wiki/Bellman%E2%80%93Ford algorithm, 2016).

A problem arises when scheduling sheets in a continuous flow for a production printer, since sheets are continuously added to the stream of sheets which are already scheduled to be printed by the production printer. For example, a pamphlet print job requires the production printer to print almost 100,000 sheets of a particular type, for example a smallest media type available. Not only scheduling 100,000 sheets takes a long time, but also for the printer to print, it does not need a schedule for all the 100,000 sheets, it just needs the schedule for the number of sheets that fit in the printer at a point of time.

It is an object of the present invention to provide a printing system that permits to increase productivity of the printing system with regard to scheduling the continuous stream of the plurality of sheets to be printed upon.

### SUMMARY OF THE PRESENT INVENTION

In order to achieve this object, according to the present invention, the scheduler comprises a digital window mover for providing subsequent windows over the directed graph, each window of the subsequent windows covering a finite subset of the vertices of the directed graph which correspond to actions on a number of subsequently sheets to be processed in the continuous flow of sheets, as to allow repetitive executions of an algorithm for finding a shortest path between vertices covered by the window, and wherein a window size determines for each window of the subsequent windows the amount of vertices in the window and a window step size determines which vertices are covered by the subsequent windows respectively.

The algorithm may be optimized according to known optimization measures for the algorithm. Instead of optimizing the algorithm faster hardware like fast GPU, FPGA, etc. may be used to get the results faster with the standard algorithm.

Experiments have revealed that the invention performs well at a print speed of 300 A4 sized images per minute and is suitable to achieve the required production performance of 300 A4 sized images per minute.

According to an embodiment the window size is determined by the number of sheets that is present in the paper path of the printing system at any point of time between the loading of the sheets and the unloading of the sheets. Such a number of sheets depends on the size of the sheets, the size of the duplex loop, for example measured in sheets containable in the duplex loop, etc.

The present invention also relates to a method for time scheduling a continuous flow of sheets in a loop of a printing system which comprises a controller for controlling simplex and/or duplex printing of image data on a plurality of sheets of the continuous flow and scheduling the plurality of sheets in a printing order, a paper path comprising the loop in order to enable printing on the plurality of sheets in an interweaving first and second pass in the loop, and a print head or print assembly for disposing marking material on the sheets according to the image data, wherein the method comprises the steps of
time scheduling the continuous flow of sheets in an order of a plurality of actions comprising loading a sheet, printing the sheet in a first pass in the loop, printing the sheet in a second pass in the loop, and unloading the sheet,
using a digital representation of a directed graph of vertices and edges, each vertex representing an action of the plurality of actions on a sheet of the continuous flow of sheets and each edge representing at least one amount of time needed for a sheet to go from a starting vertex of the edge to an ending vertex of the edge, the directed graph also representing interweaving of sheets from a first pass and a second pass,
providing subsequent windows over the directed graph, each window of the subsequent windows covering a finite subset of the vertices of the directed graph which correspond to actions on a number of subsequently sheets to be processed in the continuous flow of sheets,
allowing repetitive executions of an algorithm for finding a shortest path between vertices covered by each window,
determining for each window of the subsequent windows the amount of vertices in the window by means of window size, and
determining which vertices are covered by the subsequent windows respectively by means of a window step size.

The scheduler is modified to supply the printer schedules of only those sheets that will be in the printer at a point of time. The only constraint is that, for the printer to be able to output one sheet in every predetermined time period, the schedule for the number of sheets that fill the printer should be made available every predetermined time period.

According to an embodiment the method comprises the step of separating valid interweaving of sheets from a first pass and a second pass from invalid interweaving of sheets from a first pass and a second pass.

The present invention also relates to a software product comprising program code on a non-transitory computer-readable medium, wherein said program code, when loaded into a computer that is connected to a printing system according to the invention causes the computer to act according to any of the methods according to the invention.

### BRIEF DESCRIPTION OF THE DRAWINGS

Preferred embodiments will now be described in conjunction with the drawings, wherein:

FIG. 1 is a schematic view of the printing system according to the present invention;

FIG. 2 is a schematic view of the order of the sections of the printing system according to the present invention;

FIG. 3 is a constraint graph of a sheet to be printed according to the present invention;

FIG. 4 is the constraint graph of a sheet to be printed accompanied with starting times of operations, time needed to process the operations and set up times between operations according to the present invention;

FIGS. 5-6 are constraint graphs with multiple sheets according to the present invention.

FIG. 7 is a constraint graph example with sheets after interleaving;

FIG. 8 is a constraint graph example with regular interleaving;

FIG. 9 is a constraint graph example with exceptional interleaving;

FIG. 10 is a constraint graph example with flush interleaving;

FIG. 11 is a constraint graph example with forward interleaving;

FIG. 12 is a constraint graph example with reverse interleaving;

FIG. 13 is a constraint graph example for windowing 96 sheets according to the present invention;

FIG. 14 is a constraint graph example for windowing 96 sheets showing a first window according to the present invention;

FIG. 15 is a constraint graph example for windowing with 96 sheets showing interleavings in the first window according to the present invention.

FIG. 16 is a constraint graph example for windowing with 96 sheets when the window moves one sheet forward according to the present invention;

FIG. 17 is a constraint graph example for windowing with 96 sheets when the window moves two sheets forward according to the invention; and

FIG. 18 is a constraint graph example for windowing with 96 sheets when the window moves three sheets forward according to the invention.

### DETAILED DESCRIPTION OF THE PREFERRED EMBODIMENTS

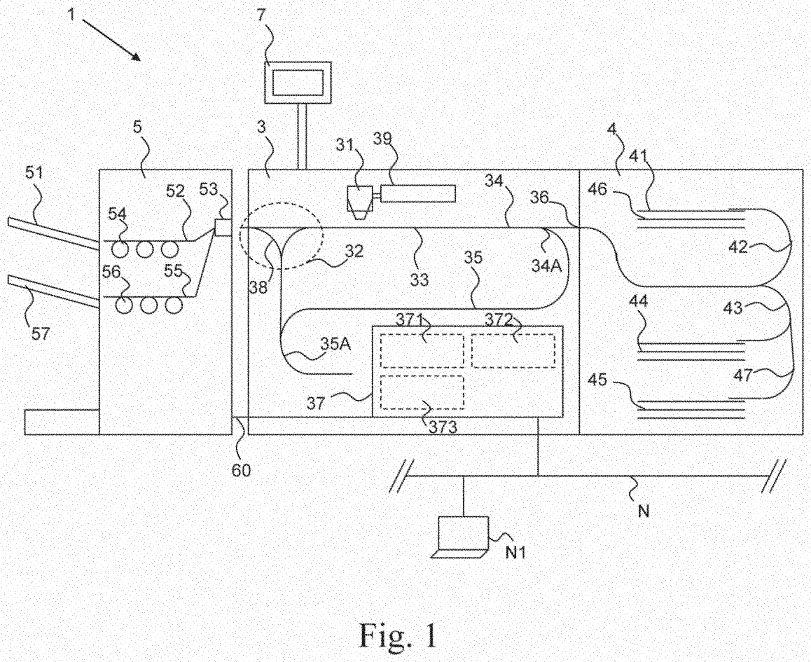

FIG. 1 shows schematically an embodiment of a printing system 1 according to the present invention. The printing system 1, for purposes of explanation, is divided into an output section 5, a print engine and control section 3, a local user interface 7 and an input section 4. While a specific printing system is shown and described, the disclosed embodiments may be used with other types of printing system such as an ink jet print system, an electrographic print system, etc.

The output section 5 comprises a first output holder 52 for holding printed image receiving material, for example a plurality of sheets. The output section 5 may comprise a second output holder 55. While 2 output holders are illustrated in FIG. 1, the number of output holders may include one, two, three or more output holders. The printed image receiving material is transported from the print engine and control section 3 via an inlet 53 to the output section 5. When a stack ejection command is invoked by the controller 37 for the first output holder 52, first guiding means 54 are activated in order to eject the plurality of sheets in the first output holder 52 outwards to a first external output holder 51. When a stack ejection command is invoked by the controller 37 for the second output holder 55, second guiding means 56 are activated in order to eject the plurality of sheets in the second output holder 55 outwards to a second external output holder 57.

The output section 5 is digitally connected by means of a cable 60 to the print engine and control section 3 for bi-directional data signal transfer.

The print engine and control section 3 comprises a print engine and a controller 37 for controlling the printing process and scheduling the plurality of sheets in a printing order before they are separated from input holder 44, 45, 46.

The controller 37 is a computer, a server or a workstation, connected to the print engine and connected to the digital environment of the printing system, for example a network N for transmitting a submitted print job to the printing system 1. In FIG. 1 the controller 37 is positioned inside the print engine and control section 3, but the controller 37 may also be at least partially positioned outside the print engine and control section 3 in connection with the network N in a workstation N1.

The controller 37 comprises a print job receiving section 371 permitting a user to submit a print job to the printing system 1, the print job comprising image data to be printed and a plurality of print job settings. The controller 37 comprises a print job queue section 372 comprising a print job queue for print jobs submitted to the printing system 1 and scheduled to be printed. The controller 37 comprises a sheet scheduling section 373 for determining for each of the plurality of sheets of the print jobs in the print job queue an entrance time in the paper path of the print engine and control section 3, especially an entrance time for the first pass and an entrance time for the second pass in the loop in the paper path according to the present invention. The sheet scheduling section 373 will also be called scheduler 373 hereinafter.

The sheet scheduling section 373 takes the length of the loop into account. The length of the loop corresponds to a loop time duration of a sheet going through the loop dependent on the velocity of the sheets in the loop. The loop time duration may vary per kind of sheet, i.e. a sheet with different media properties.

Resources may be recording material located in the input section 4, marking material located in a reservoir 39 near or in the print head or print assembly 31 of the print engine, or finishing material located near the print head or print assembly 31 of the print engine or located in the output section 5 (not shown).

The paper path comprises a plurality of paper path sections 32, 33, 34, 35 for transporting the image receiving material from an entry point 36 of the print engine and control section 3 along the print head or print assembly 31 to the inlet 53 of the output section 5. The paper path sections 32, 33, 34, 35 form a loop according to the present invention. The loop enables the printing of a duplex print job and/or a mix-plex job, i.e. a print job comprising a mix of sheets intended to be printed partially in a simplex mode and partially in a duplex mode.

The print head or print assembly 31 is suitable for ejecting and/or fixing marking material to image receiving material. The print head or print assembly 31 is positioned near the paper path section 34. The print head or print assembly 31 may be an inkjet print head, a direct imaging toner assembly or an indirect imaging toner assembly.

While an image receiving material is transported along the paper path section 34 in a first pass in the loop, the image receiving material receives the marking material through the print head or print assembly 31. A next paper path section 32 is a flip unit 32 for selecting a different subsequent paper path for simplex or duplex printing of the image receiving material. The flip unit 32 may be also used to flip a sheet of image receiving material after printing in simplex mode before the sheet leaves the print engine and control section 3 via a curved section 38 of the flip unit 32 and via the inlet 53 to the output section 5. The curved section 38 of the flip unit 32 may not be present and the turning of a simplex page has to be done via another paper path section 35.

In case of duplex printing on a sheet or when the curved section 38 is not present, the sheet is transported along the loop via paper path section 35A in order to turn the sheet for enabling printing on the other side of the sheet. The sheet is transported along the paper path section 35 until it reaches a merging point 34A at which sheets entering the paper path section 34 from the entry point 36 interweave with the sheets coming from the paper path section 35. The sheets entering the paper path section 34 from the entry point 36 are starting their first pass along the print head or print assembly 31 in the loop. The sheets coming from the paper path section 35 are starting their second pass along the print head or print assembly 31 in the loop. When a sheet has passed the print head or print assembly 31 for the second time in the second pass, the sheet is transported to the inlet 53 of the output section 5.

The input section 4 may comprise at least one input holder 44, 45, 46 for holding the image receiving material before transporting the sheets of image receiving material to the print engine and control section 3. Sheets of image receiving material are separated from the input holders 44, 45, 46 and guided from the input holders 44, 45, 46 by guiding means 42, 43, 47 to an outlet 36 for entrance in the print engine and control section 3. Each input holder 44, 45, 46 may be used for holding a different kind of image receiving material, i.e. sheets having different media properties. While 3 input holders are illustrated in FIG. 1, the number of input holders may include one, two, three or more input holders.

The local user interface 7 is suitable for displaying user interface windows for controlling the print job queue residing in the controller 37. In another embodiment a computer N1 in the network N has a user interface for displaying and controlling the print job queue of the printing system 1.

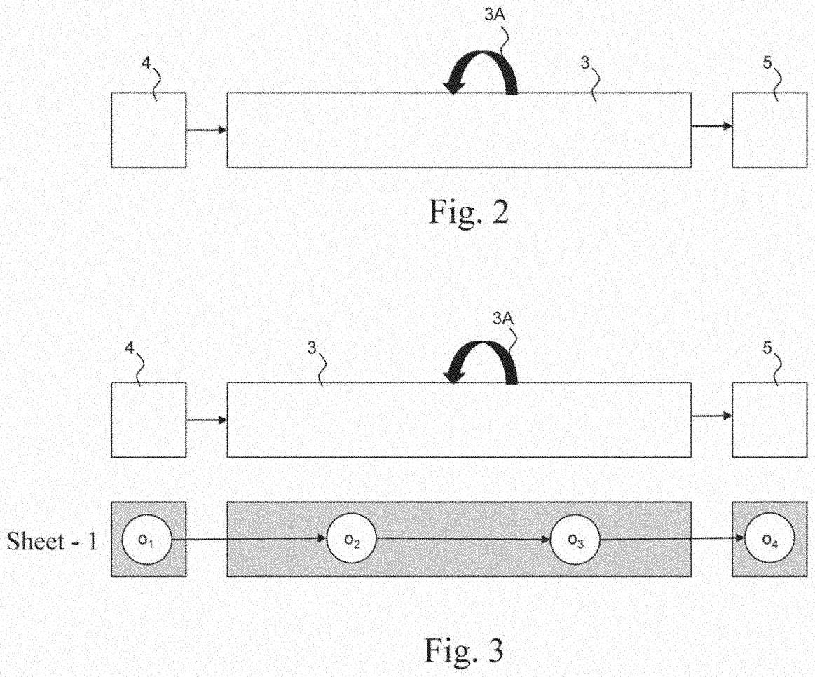

FIG. 2 schematically shows the sections 3,4,5 of the production printer 1 and the path a sheet needs to take from the input section 4 via the print engine and control section 3 to the output section 5. The scheduler 373 residing in the controller 37 models the scheduling of the sheets in the production printer 1 as a re-entrant flowshop problem and solves it by using constraint graphs. For convenience reasons, each print job is assumed to be a duplex print job. Since every sheet is to be assumed to be a duplex sheet and therefore has to re-enter the print engine and control section 3 in order to be printed on a second side. The re-entry into the print engine and control section 3 is denoted using the loop 3A on top of the image representing the print engine and control section 3.

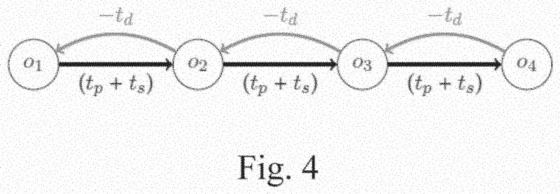

To model the problem into a constraint graph shown in FIG. 3, the model shown in FIG. 2 for the sections 3, 4, 5 of the production printer 1 is used. The input section 4 and the output section 5 do one operation each per sheet i.e., the input section 4 inputs the sheet and the output section 5 outputs the sheet. The print engine and control section 3 has to execute two operations per sheet, each operation denotes a print on each side of the sheet. So, printing of one sheet can be shown as an ordered set of four operations, a first operation o1 is to input the sheet at the input section 4, a second and a third operations o2, o3 show printing on each side of the sheet at the print engine and control section 3 and finally a fourth operation o4 is to output of the printer at the output section 5.

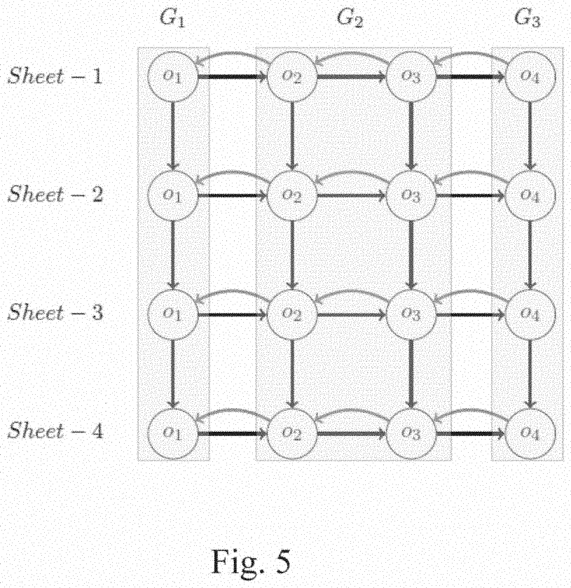

FIG. 3 shows the operations as vertices. The edges between the operations enforce the order from first operation o1 to the last operation o4. For an operation to begin executing at its section, the operation should wait until its predecessor operation is executed along with the time that is needed for the section to complete its setup. Predecessors can be recognized using the edges incoming to a vertex. So, each edge will have a weight which is the sum of predecessor operation's processing time tp and setup time ts needed between the two operations, shown as tp+ts. This edge is referred as a forward edge and gives a constraint for a minimum time that is needed. There is also a maximum time that an operation can wait, called a reverse due date td. This is shown using an edge incoming to the operation but with negative weight. This edge is referred to as a reverse edge. FIG. 4 shows the constraint graph of one sheet with both forward and reverse edges.

For example, the forward edge constraint between operations o1 and o2 in FIG. 4 can be written as, to2□to1+(tp+ts). to1 and to2 are the start times of operations o1 and o2, tp is the time needed to process operation o1 and ts is the setup time between the operations o1 and o2. This constraint gives the minimum time operation o2 needs to wait before it can begin after o1 has started executing. The reverse edge constraint between operations o2 and o1 can be written as, to1□to2−td. This gives the maximum time that o1 can wait before it needs to begin its execution. The scheduling algorithm computes start times of operations of all sheets. The set of start times of all these operations is referred to as a schedule.

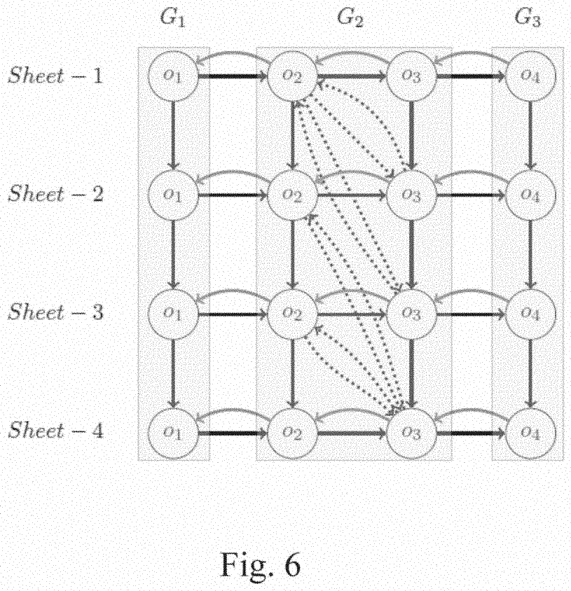

FIG. 3 and FIG. 4 show the constraint graph for one sheet. When there are multiple sheets to be printed, the graph should not only need constraints to show the order of operations, additional constraints are needed to enforce the order of sheets. Extra sets of edges are used to join similar operations of different sheets to enforce these constraints. To denote the constraints between the different sheets FIG. 5 shows the constraint graph with multiple sheets 1-4. The operations that are to be executed on a section for each sheet are shown in blocks and operations in each block are referred to as a group (shown as G1, G2 and G3 in FIG. 5).

The group of vertices G1 and G3 are mapped to the input section 4 and the output section 5 respectively and need no sequencing because there is only one operation per sheet that is mapped to these sections and because these sheets are ordered, the corresponding operations are also ordered.

The remaining group is G2. The operations of group G2 are mapped to the print engine and control section 3. Unlike the other groups, the group G2 has two operations from each sheet. So, the scheduler 373 is provided an opportunity to re-order the operations so that a makespan is kept minimal.

All the edges shown in FIG. 5 need to be satisfied, if not the computed schedule will be invalid and will lead to errors during printing. Therefore, the constraints on the edges form compulsory constraints.

With these compulsory constraints, the default ordering of the operations will be, o2, o3 of a sheet will execute and only after these two operations are finished, next sheet's o2, o3 can start. This order goes from a first sheet to a last sheet. But, because the printer can hold a buffer of sheets before it can begin printing second side prints of sheets, as long as the compulsory constraints are satisfied, there can be other sequences too. To find these orderings in the operations in group G2, the scheduling algorithm uses extra constraints. These extra constraints are shown using dotted edges in FIG. 6 and will represent an amount of time that each sheet can take before it can begin its second side print. The scheduler 373 may find a different ordering for the operations in group G2 using these dotted edge constraints which when compared to the default ordering can result in a lesser makespan. Since the constraints on these dotted edges are not compulsorily needed to be satisfied and are only used when necessary, these set of dotted edges are referred to as optional constraints.

In the printer paper path shown in FIG. 1, the only place the scheduling algorithm can make a decision for a different ordering is at the merging point 34A. The decision that the scheduler 373 needs to take is, between which two sheets' print operations can a different sheet coming from the re-entrant path 35 enter into main path 34 at the merging point 34A and execute its print operation. This decision is called an interleaving. Because this decision is made on a sheet that is coming from the re-entrant path 35, an interleaving always refers to a decision stated as “between which two sheet's first print operations, a sheet's second print can be executed”.

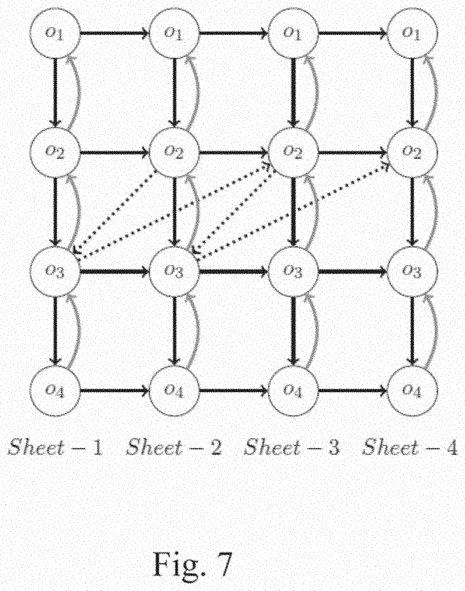

For example, consider four sheets 1-4 shown in FIG. 7. For convenience reasons, the constraint graph shown in FIG. 5 is rotated by 90 degrees and is shown in FIG. 7. In FIG. 7, each column denotes a sheet. As explained above, the scheduler 373 need to find an interleaving for all the sheets in the queue. In a default ordering, each sheet is interleaved with the next sheet's first print. In an ordering which has a different sequence of operations when compared to the default case, dotted lines show the interleavings. For example, the incoming and outgoing edges from operation o3 of Sheet-1 show that, the second print of Sheet-1's second print operation goes in between Sheet-2 and Sheet-3 instead of itself and Sheet-2's first print operations. Similarly the Sheet-2's second print operation goes between Sheet-3 and Sheet-4's first print operations.

An interleaving is an ordered tuple, OT((a,b),(b, c)) where a, b, and c denote vertices. The ordered tuple OT((a,b),(b, c)) also means that the operation denoted by vertex b is executed after a is executed and before c is executed. An interleaving is said to be feasible if the ordering does not create a cycle in the compulsory constraint graph. Only after an interleaving is found to be feasible, the edges of this interleaving between vertices (a, b) and (b, c) are added to the compulsory constraint edges.

The scheduling problem is to find the feasible set of ordering tuples in OT such that all the vertices in all the groups which have multiple operations per job mapped to a same machine are ordered such that the makespan is kept minimal.

There are three types of interleavings possible to schedule a sheet in queue.

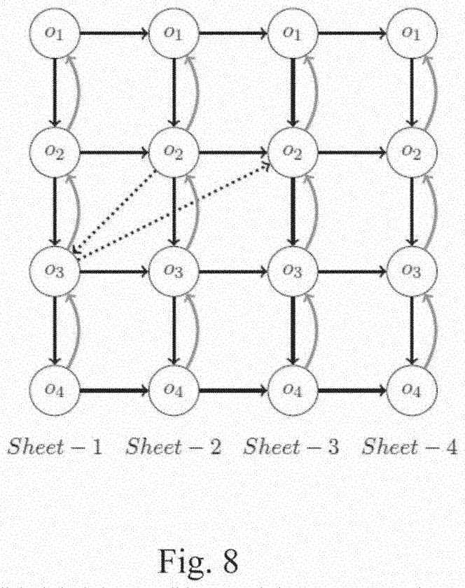

Firstly, a regular interleaving denotes a sheet's ordering between “first prints” of two other sheets in the queue. This is shown in FIG. 8. It will be referred to as an interleaving hereinafter.

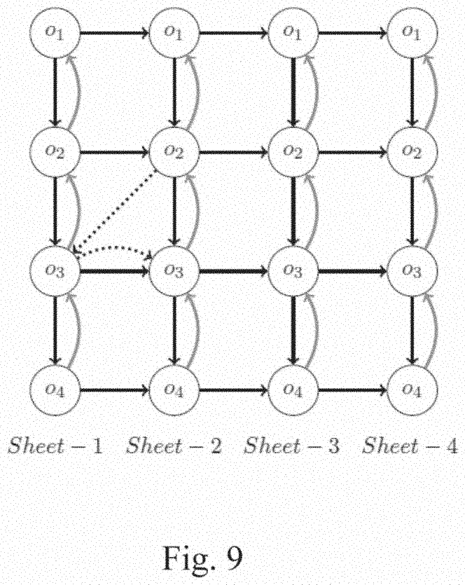

Secondly, an exceptional interleaving denotes an interleaving when a sheet's second print operation is interleaved with first and second print operations of a sheet in the queue. This is different from the above discussed regular interleaving because this interleaving is only with one sheet (its first and second print operations), instead of two different sheets' first print operations. In example shown in FIG. 9, because of the exceptional interleaving the Sheet-3 can begin printing on its first side only after Sheet-2 finishes its second side print.

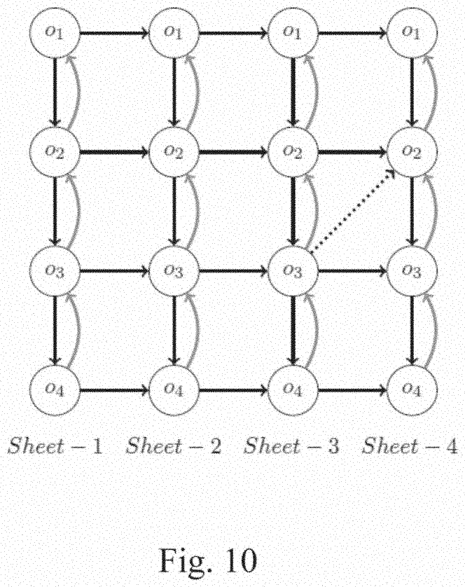

Thirdly, a flush interleaving, as its name suggests will flush the duplex loop before next sheet starts its first print operation. In an example shown in FIG. 10, because of the flush interleaving the Sheet-4 can start printing on its first side only after Sheet-3 finishes its second side print.

Because the two interleavings, exceptional and flush, are used to clear the duplex loop, these two interleavings are time expensive interleavings.

The Bellman-Ford algorithm computes shortest paths to all vertices from a source vertex. But for the production printer scheduler 373, as explained here-above, all compulsory constraints need to be satisfied before an operation can start its execution. This means that if an operation has two incoming edges that belong to the compulsory constraint edges, then constraints on both edges need to be satisfied, i.e., the operation can only start its execution after both the operations on the other side of the incoming edges have finished their execution. This means, instead of computing shortest path, to compute the start times, a longest path needs to be computed. The source to destination longest path can be computed by inverting the signs of edge weights on the constraint graph. For simplicity, all the optimizations are explained on the algorithm that computes the shortest paths, but just by changing the sign of the edges, the same optimizations will work to compute the longest path.

A heuristic approach is a practical way of exploring the solution space for a problem. The scheduler's problem here is to explore the different solutions of re-ordering of operations on sections which have more than one operation per job mapped to them in order to minimize the makespan. The scheduler 373 needs to decide between which sheets does the re-entering sheet enter the main path 34 and is printed on its second side. In flowshop and constraint graph terminology, an ordering tuple need to be computed for each re-entering operation, say ((a,b), (b,c)), where b denotes the re-entering operation, and a and c represent the two operations between which b is executed. For such a re-entering operation there may be more than one valid ordering tuple and the makespan of the final schedule depends on how the heuristic algorithm selects a final ordering tuple. The heuristic approach that Waqas et al. presents is a generic algorithm which will compute a schedule for constraint graphs of re-entrant flowshop type problems. The production printer scheduling is one such flowshop problem with one re-entrant section. Since the problem has only one re-entrant section there is only one group for the scheduler 373 to re-order.

The algorithm has to compute the ordered tuples for each re-entering operation, called interleaving and is denoted by OTsol. To do so, first the algorithm needs a solution space to explore the interleaving solutions. There are two ways to compute interleaving solution space for re-entering operations.

A first way is called “forward interleaving”.

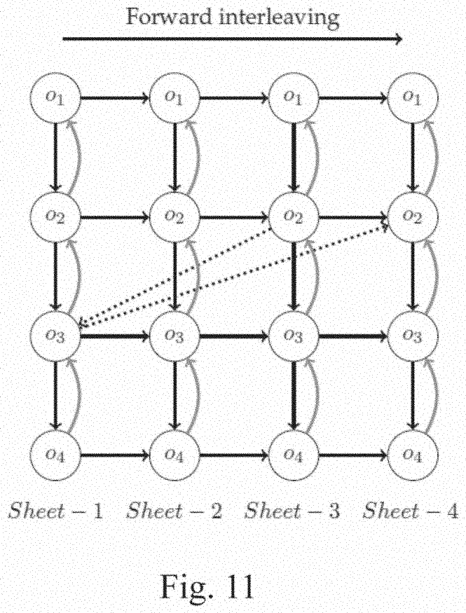

Interleavings are computed from a first sheet to a last sheet in that order. FIG. 11 gives an example of forward interleaving. In the example, interleaving begins from Sheet-1 and FIG. 11 shows that Sheet-1 is interleaved with Sheet-3 and Sheet-4. So, ordered tuple for Sheet-1 can be written as ((Sheet-3, Sheet-1), (Sheet-1, Sheet-4)). This means the Sheet-1 can execute its second print after the first side of Sheet-3 has finished its execution and before Sheet-4 has started its first side print.

A second way is “reverse interleaving”.

In reverse interleaving, interleavings are computed from a last sheet to a first sheet. In the example, the interleaving begins at Sheet-4. But since Sheet-4 is the last sheet and there are no sheets after it in the queue, there is no interleaving needed for the last sheet. So, interleaving begins at the pen-ultimate sheet, Sheet-3. Sheet-3 has only two interleavings possible, either the exceptional interleaving or the flush interleaving. Sheet-2 now has all three types of interleavings possible and so can Sheet-1.

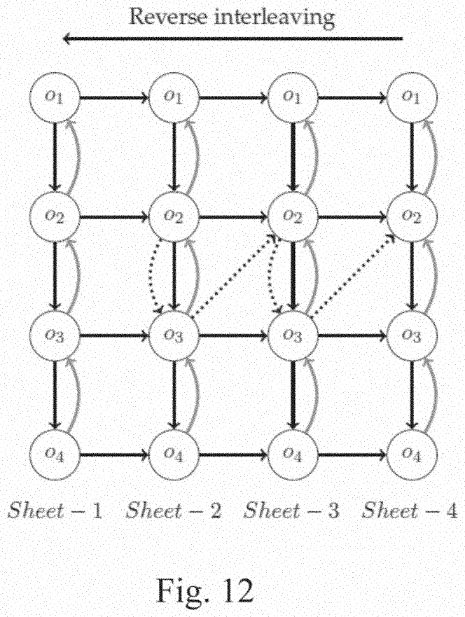

FIG. 12 shows both Sheet-2 and Sheet-3 with flush interleaving, i.e., Sheet-3 can begin its first side print only after Sheet-2 has finished its both side prints and Sheet-4 can begin its first side print only after Sheet-3 has finished its both side prints.

Having an option to flush when interleaving a sheet is preferred because it will act like a fall-back in case of any errors during scheduling. In forward interleaving, shown in FIG. 11, when the scheduler 373 tries to interleave Sheet-2's second print operation, Sheet-2 has no option to flush because Sheet-1 is interleaved between Sheet-3 and Sheet-4. But, as shown in FIG. 12, with reverse interleaving it is always possible to have an option to flush for every sheet. Therefore, if reverse interleaving is used, it is a definite possibility that every sheet will have a valid interleaving choice. So, the production printer scheduler 373 will preferably use the reverse interleaving technique to create the interleaving solution space.

The scheduler 373 takes a heuristic approach by using three metrics to understand the effect of an ordering tuple on the makespan. The three metrics are productivity, flexibility and distance.

The productivity of an ordering tuple measures the impact of the ordering tuple on the makespan. To calculate a productivity metric of the ordering tuple ((a,b),(b,c)), first the scheduler 373 computes the maximum possible increase in start time of the operation c (denoted by dx;b), that can be caused by one of the ordering tuples of b (denoted by OTxb), where x and b denote the group and vertex which are currently being ordered.

$${d}_{x , b} = {max}_{ot ∈ {OT}_{b}^{x}} max ( {t}_{c} , max ( {t}_{b} , {t}_{a} + w ( a , b ) ) + w ( b , c ) )$$

The productivity metric denotes how restrictive the ordering tuple is. So, Pot=0 denotes a highly productive ordering tuple. The productivity of an ordering tuple can be given by the equation:

$${P}_{ot} = \frac{max ( {t}_{c} , max ( {t}_{b} , {t}_{a} + w ( a , b ) ) + w ( b , c ) ) - {t}_{c}}{{d}_{x , b}}$$

The flexibility of an ordering tuple ((a,b),(b,c)), measures the effect of edges over the due date constraints of vertex b. If Db contains all the negative edges going out of vertex b, the flexibility is given as:

$${F}_{ot} = {min}_{( b , x ) ∈ {D}_{b}} \frac{max ( {t}_{b} , {t}_{a} + w ( a , b ) ) - {t}_{b}}{- w ( b , b - 1 ) - w ( b - 1 , b )}$$

The above equation Fot denotes a ratio of excess usage of a time by the ordering tuple to a total allowed time by a due date constraint. The terms tb and tx are a start time of the vertices band x, computed from the partial solution (the compulsory constraint edges set and OTsol at that point of time).

A distance denotes the length of interleaving of the vertex c. It is given by the following formula.

$${D}_{ot} = \frac{\vert V \vert - {dist}_{c}}{\vert V \vert}$$

where |V| denotes the number of vertices and disk denotes the minimum number of edges from source vertex vₛ to c.

The weight of an ordering tuple is computed by weighted sum of all the three metrics calculated for each ordering tuple. It is given by the following equation.

Rₒₜ=κ_{P}×Pₒₜ+κ_{F}×Fₒₜ+κ_{D}T×Dₒₜ

The relative weights, κP, κF and κDT indicate the relative importance to the metrics and sum up to 1.

The heuristics are modeled in such a way that, as the weight of an interleaving option increases, its rank decreases. Therefore, lower the weight, higher the rank.

The complete heuristic approach is explained hereinafter.

The algorithm as explained above uses reverse interleaving, so the interleaving begins at the penultimate sheet in the queue. The algorithm is explained in steps below.

Step-1: The algorithm selects a sheet's second side print operation and computes all its valid interleavings.

Step-2: All the valid interleavings are weighted and ranked using the metrics mentioned here-above. The interleaving with lowest weight will be given highest rank.

Step-3: Check the feasibility of the interleavings in the order of their ranking.

Step-4: Highest ranked feasible interleaving will be selected and its edges are added to the compulsory edges set and the interleaving will be added to the final set of ordered tuples OTsol. While computing each sheet's interleaving the schedule (start times) of the operations of sheets in the queue will be computed and will be used during ranking of the interleavings. This is denoted by T in the algorithm.

Final step: The algorithm finally returns the schedule after all sheets are interleaved.

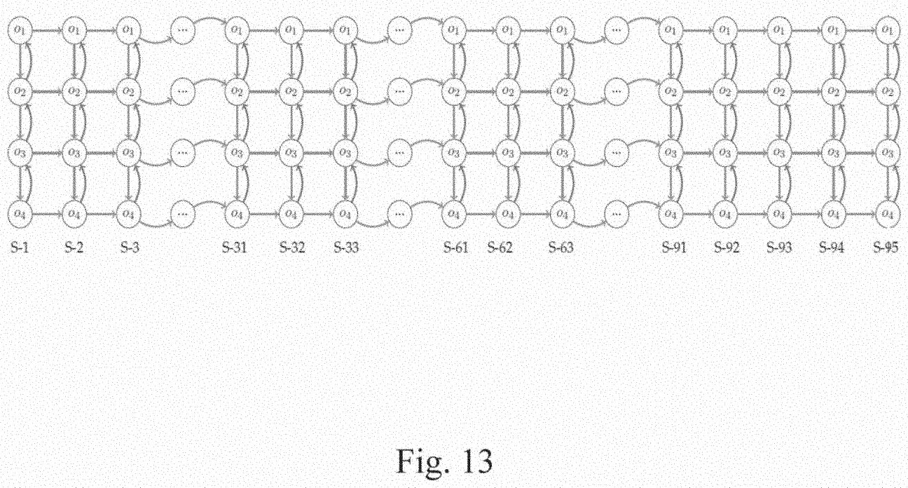

FIG. 13 shows an example print job with 95 sheets.

The number of sheets that a printer can hold at any point of time, most importantly depends on the size of the sheets that are to be printed, on the number of input holders at the beginning of the printer, etc. But for this example the number is considered to be 60. And assuming the loop filling from merge-point 34A to merge-point 34A in FIG. 1 is around 32, the number can increase up to 92.

Because the printer can hold up to 92 sheets of smallest possible sheet size, below example assumes sheets are of smallest possible size. This means that a window according to this example may contain 92 sheets.

In a non-windowed case, a scheduler will compute interleavings for all sheets in the job. A job may contain any arbitrary number of sheets in it. Only after 95 sheets are scheduled, the printer begins printing. But in the windowed scheduler 373 according to the invention, instead of scheduling all sheets, the scheduler 373 schedules only those sheets that fill the printer. The printer needs no more than 92 sheets to generate valid schedules and therefore the number of sheets in the window is limited to 92. According to a preferred embodiment the scheduler 373 uses only the required number of sheets in contrast with the solution of the flowshop problem called “A re-entrant flowshop heuristic for online scheduling of the paper path in a large scale printer” as described by Umar Waqas et al. (“Proceedings of the 2015 Design, automation & Test in Europe Conference & Exhibition”. DATE '15. Grenoble, France: EDA Consortium, 2015, pp. 573-578. ISBN 978-3-9815370-4-8).

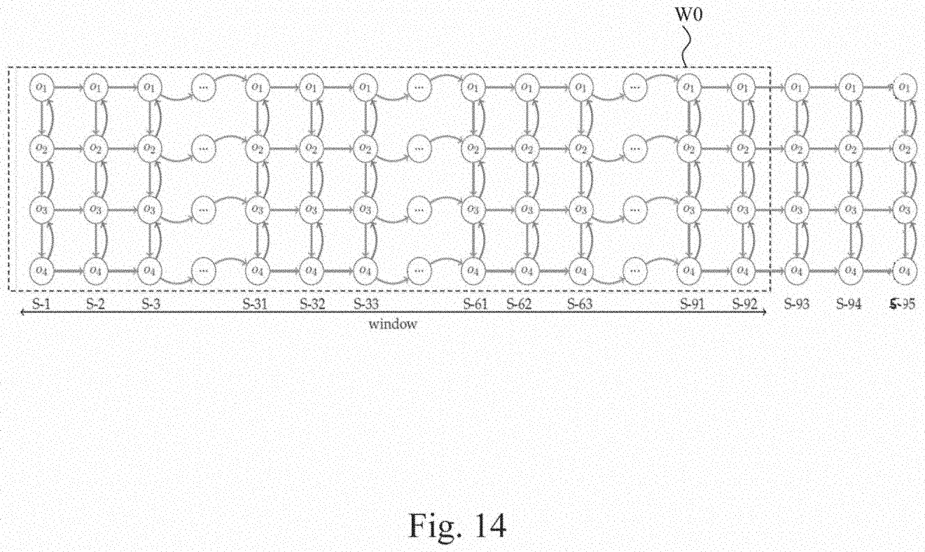

In FIG. 14, the sheets surrounded by a box W0 denote the sheets that are scheduled in a first window W0. As it is done in the non-windowed case, the scheduler 373 assumes the jobs end at sheet 92 and schedule the sheets.

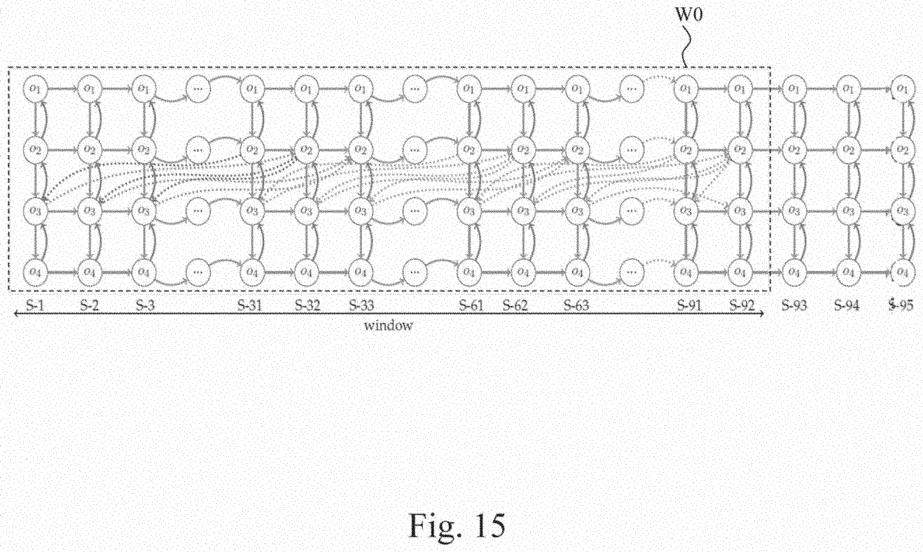

FIG. 15 shows the interleavings done in the first window W0. After scheduling the first window W0, the scheduler 373 now has start times for all the operations of 92 sheets in the window W0 which the printer can use to begin printing. Now, instead of sending schedules of all 92 sheets in the window W1, the scheduler 373 may be configured to send schedules of only first k sheets (k<92). This is referred to as a step size denoted S, because a next window has to step forward leaving only S sheets behind and not all 92 sheets. This will help the sheets in the next window to make better interleaving choices with the sheets that have newly entered into the window after the window has moved.

After scheduling each window, the scheduler 373 fixes schedules of only S sheets and not necessarily all sheets in order to make better interleaving choices with new sheets.

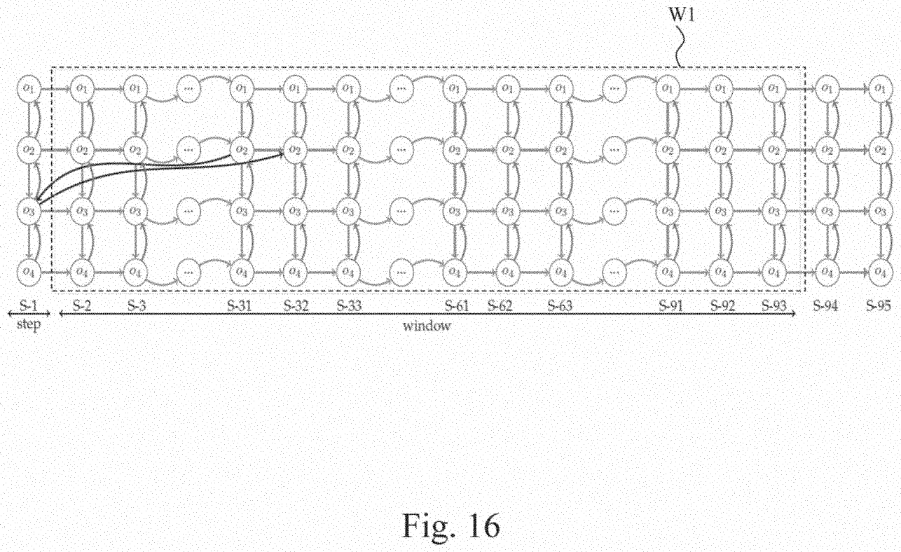

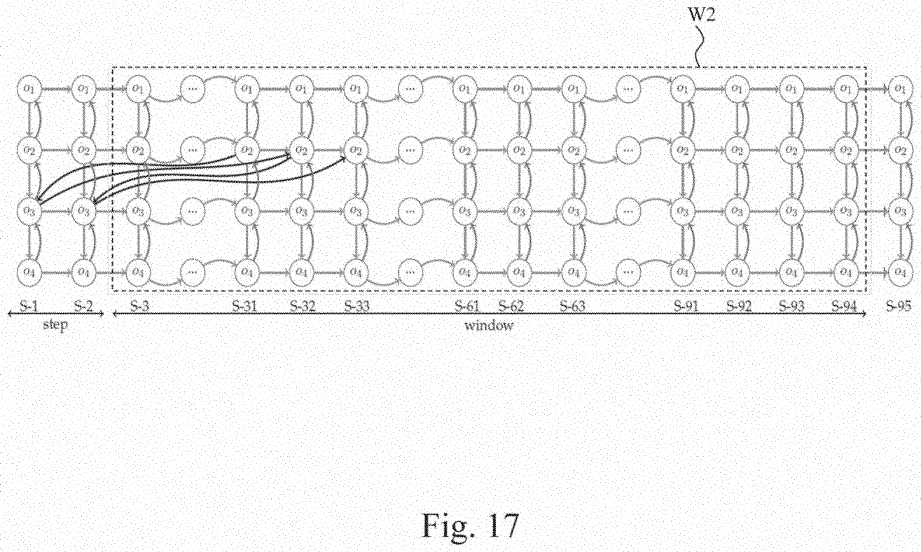

FIGS. 16-18 show the constraint graphs when the window fixes the start times of the first one, two and three sheets respectively i.e., step size S=1, 2 and 3. Then the window W0 moves forward to compute the schedule for the next window out of the windows W1, W2, W3 respectively. Because the start times of these sheets are fixed, their respective interleavings are also fixed. The dark edges shown in FIGS. 16-18 denote the interleavings of the sheets whose start times are fixed when the window W0 moved. Also, the printer may start printing the first step S of sheets whose schedule is fixed.

It is not profitable to move the window completely by 92 sheets because the pen-ultimate sheet in the window W0 (S-91) is interleaved using the exceptional interleaving, this means, every time the window moves completely by 92 sheets, the printer loop needs to be cleared before first sheet from the next window begins. This clearance consumes more time because, after emptying the loop, as explained above, the printer needs, for example, a maximum time of 92×400 ms time to reach a steady rate of printing a sheet every 400 ms.

As explained above, not moving the window completely by 92 sheets gives an opportunity for the scheduler 373 to explore new interleaving options for the sheets in the window. For example, in the first window W0 shown in FIG. 15, the pen-ultimate sheet S-91 has only two interleaving options, either exceptional interleaving or flush interleaving. But when the window W0 moved by one sheet into window W1, shown in FIG. 16, the pen-ultimate sheet S-91 can now interleave between first prints of S-92 and S-93. This means the printer does not have to clear its loop, which will help in keeping the makespan minimal.

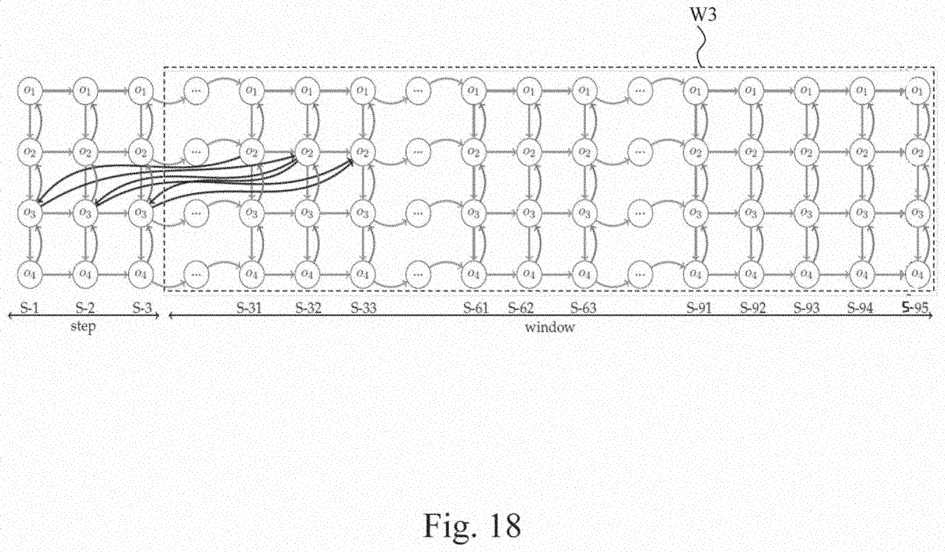

In order to explore new interleaving options for the sheets which remained in the window even after moving, the old interleavings need to be removed from the compulsory constraint edges set. This means, before the scheduler begins to interleave a next window, it needs to remove the interleavings of the sheets that were common to the previous window. For example, in FIG. 16, all sheets' interleavings except S-1 need to be removed because the second window W1 has all sheets from S-2 to S-92 common to the first window W0 to which the second window W1 can explore new interleavings and a new sheet at the end, S-93. Similarly, when window W0 moves three sheets into a window W3 shown in FIG. 18, interleavings of only a first three sheets S-1, S-2 and S-3 are fixed and all other interleavings are removed before the next window is scheduled.

When the algorithm fixes the start times of certain operations, the printer can begin using these start times and begin printing. Therefore, when the window moves from these scheduled fixed sheets, the interleavings chosen in that window should not disturb these fixed schedules, otherwise it will cause errors during printing. Therefore, the selection criteria for interleavings changes in the windowed heuristic algorithm. In the next window interleavings should be chosen in such a way that, the interleavings should not only cause no positive cycles, but also should not change the fixed schedules of the sheets which left the window. This helps in maintaining the feasibility of the constraint graph. Only positive cycles are a problem. There are always cycles due to the reverse edge of due dates. But if there is a positive cycle, then it means that the assigned times are larger than the deadlines and therefore they are infeasible.

The algorithm is explained below in a set of steps.

Step-1: The algorithm selects the parameters to denote where the window begins and ends.

Step-2: Using reverse interleaving technique, the algorithm interleaves all the sheets in the window (from window end to window start).

Step-3: For each sheet, the algorithm computes all of its valid interleaving choices.

Step-4: These interleavings are weighted and ranked using the metrics mentioned before. The interleaving with lowest weight will be given highest rank.

Step-5: Select highest ranked feasible interleaving that does not disturb previously fixed start times.

Step-6: This interleaving's edges are added to compulsory edges set and the interleaving will be added to the final set of ordered tuples OTsol.

Step-7: Depending on how many number of sheets the window is moving, referred to as step S, the start times of the operations of the sheets leaving the window will be fixed, i.e., they are added to Tsol.

Step-8: Apart from the first step of sheets in the window whose schedules are fixed, all other sheet's interleavings are removed before scheduling the next window.

The above given algorithm discusses the windowed version of the scheduling algorithm according to the present invention.

The skilled person will recognise that other embodiments with respect to the printing system and the method are possible within the scope of the appended claims.

1. A printing system for cut sheets, the printing system comprising a paper path comprising a loop in order to enable duplex printing on the sheets in a continuous flow of sheets in a first and second interweaving pass in the loop, a controller for controlling simplex and/or duplex printing of image data on the continuous flow of sheets, a print engine positioned in the loop configured to dispose marking material on the sheets according to the image data, and a scheduler for time scheduling the continuous flow of sheets in an order of a plurality of actions comprising loading a sheet, printing the sheet in a first pass in the loop, printing the sheet in a second pass in the loop, and unloading the sheet,
wherein the scheduler is configured to use a digital representation of a directed graph of vertices and edges, each vertex representing an action of the plurality of actions on a sheet of the continuous flow of sheets and each edge representing at least one amount of time needed for a sheet to go from a starting vertex of the edge to an ending vertex of the edge, the directed graph also representing interweaving of sheets from a first pass and a second pass,
wherein the scheduler comprises a digital window mover for providing subsequent windows over the directed graph, each window of the subsequent windows covering a finite subset of the vertices of the directed graph which correspond to actions on a number of subsequently sheets to be processed in the continuous flow of sheets, as to allow repetitive executions of an algorithm for finding a shortest path between vertices covered by the window, and
wherein a window size determines for each window of the subsequent windows the amount of vertices in the window and a window step size determines which vertices are covered by the subsequent windows respectively.

2. The printing system according to claim 1, wherein the algorithm is an optimized Bellman-Ford-Moore algorithm.

3. The printing system according to claim 1, wherein the window size is determined by the number of sheets that is present in the paper path of the printing system at any point of time between the loading of the sheets and the unloading of the sheets.

4. The printing system according to claim 2, wherein the window size is determined by the number of sheets that is present in the paper path of the printing system at any point of time between the loading of the sheets and the unloading of the sheets.

5. A method for time scheduling a continuous flow of sheets in a loop of a printing system which comprises a controller for controlling simplex and/or duplex printing of image data on the continuous flow of sheets and scheduling a plurality of sheets of the continuous flow in a printing order, a paper path comprising the loop in order to enable printing on the plurality of sheets in an interweaving first and second pass in the loop, and a print head or print assembly for disposing marking material on the sheets according to the image data,
wherein the method comprises the steps of
time scheduling the continuous flow of sheets in an order of a plurality of actions comprising loading a sheet, printing the sheet in a first pass in the loop, printing the sheet in a second pass in the loop, and unloading the sheet,
using a digital representation of a directed graph of vertices and edges, each vertex representing an action of the plurality of actions on a sheet of the continuous flow of sheets and each edge representing at least one amount of time needed for a sheet to go from a starting vertex of the edge to an ending vertex of the edge, the directed graph also representing interweaving of sheets from a first pass and a second pass,
providing subsequent windows over the directed graph, each window of the subsequent windows covering a finite subset of the vertices of the directed graph which correspond to actions on a number of subsequently sheets to be processed in the continuous flow of sheets,
allowing repetitive executions of an algorithm for finding a shortest path between vertices covered by each window,
determining for each window of the subsequent windows the amount of vertices in the window by means of window size, and
determining which vertices are covered by the subsequent windows respectively by means of a window step size.

6. The according to claim 5, wherein the method comprises the step of separating valid interweaving of sheets from a first pass and a second pass from invalid interweaving of sheets from a first pass and a second pass.

7. A software product comprising program code on a non-transitory computer-readable medium, wherein said program code, when loaded into a computer that is connected to a printing system causes the computer to act according to the method of claim 5.

8. A software product comprising program code on a non-transitory computer-readable medium, wherein said program code, when loaded into a computer that is connected to a printing system causes the computer to act according to the method of claim 6.

9. A software product comprising program code on a non-transitory computer-readable medium, wherein said program code, when loaded into a computer that is connected to a printing system causes the computer to act according to the method of claim 5.

10. A software product comprising program code on a non-transitory computer-readable medium, wherein said program code, when loaded into a computer that is connected to a printing system causes the computer to act according to the method of claim 6.

11. A software product comprising program code on a non-transitory computer-readable medium, wherein said program code, when loaded into a computer that is connected to a printing system causes the computer to act according to the method of claim 5.

12. A software product comprising program code on a non-transitory computer-readable medium, wherein said program code, when loaded into a computer that is connected to a printing system causes the computer to act according to the method of claim 6.

13. A software product comprising program code on a non-transitory computer-readable medium, wherein said program code, when loaded into a computer that is connected to a printing system causes the computer to act according to the method of claim 5.

14. A software product comprising program code on a non-transitory computer-readable medium, wherein said program code, when loaded into a computer that is connected to a printing system causes the computer to act according to the method of claim 6.
